(19) United States
(12) Patent Application Publication
(10) Pub. No.: US 2026/0056397 A1
(43) Pub. Date: Feb. 26, 2026

(54) WOLTER MIRROR ASSEMBLY

(71) Applicant: KLA Corporation, Milpitas, CA (US)

(72) Inventors: Joseph Walsh, Soquel, CA (US); Amanjot Gill, Sacramento, CA (US); Yue Wang, San Jose, CA (US); Shuqi Zheng, San Jose, CA (US); Junwon Lee, San Jose, CA (US)

(21) Appl. No.: 19/285,583

(22) Filed: Jul. 30, 2025

Related U.S. Application Data
(60) Provisional application No. 63/685,699, filed on Aug. 22, 2024.

(51) Int. Cl. G02B 17/06; G01N 23/04; G02B 5/08

(52) U.S. Cl. CPC G02B 17/0621; G01N 23/04; G02B 5/0891; G01N 2223/052; G01N 2223/101

(57) ABSTRACT

A mirror assembly is disclosed. The mirror assembly includes an ellipsoid optical surface. The mirror assembly includes a hyperboloid optical surface, wherein the ellipsoid optical surface and the hyperboloid optical surface are arranged in a Wolter mirror configuration. The mirror assembly includes a substrate. The substrate includes a first portion, wherein the ellipsoid optical surface is located on the first portion of the substrate. The substrate includes a second portion, wherein the hyperboloid optical surface is located on the second portion of the substrate, wherein the first portion and the second portion form a monolithic body.

### CROSS-REFERENCE TO RELATED APPLICATION

The present application claims the benefit under 35 U.S.C. § 119(e) of U.S. Provisional Application Ser. No. 63/685,699, filed Aug. 22, 2024, entitled MONO WOLTER DESIGN, which is incorporated herein by reference in the entirety.

### TECHNICAL FIELD

The present disclosure relates generally to extreme ultraviolet measurement systems and, more particularly, to control of an extreme ultraviolet beam.

### BACKGROUND

Wolter optics may generally include a pair of mirrors. However, those mirrors will be separately installed in an optical system. Separate installation of the mirrors may make alignment of two mirror foci difficult. Additionally, separate installation of the mirrors may result in the optical system being subject to motion effects. Accordingly, it is desirable to develop systems and methods to address these demands.

### SUMMARY

A mirror assembly is disclosed, in accordance with one or more embodiments of the present disclosure. In embodiments, the mirror assembly includes an ellipsoid optical surface. In embodiments, the mirror assembly includes a hyperboloid optical surface, wherein the ellipsoid optical surface and the hyperboloid optical surface are arranged in a Wolter mirror configuration. In embodiments, the mirror assembly includes a substrate. In embodiments, the substrate includes a first portion, wherein the ellipsoid optical surface is located on the first portion of the substrate. In embodiments, the substrate includes a second portion, wherein the hyperboloid optical surface is located on the second portion of the substrate, wherein the first portion and the second portion form a monolithic body.

An extreme ultraviolet inspection system is disclosed, in accordance with one or more embodiments of the present disclosure. In embodiments, extreme ultraviolet inspection system includes an extreme ultraviolet illumination source, wherein the extreme ultraviolet illumination source is configured to generate an extreme ultraviolet beam. In embodiments, extreme ultraviolet inspection system includes one or more illumination optics, wherein the one or more illumination optics includes one or more mirror assemblies, wherein the one or more mirror assemblies are configured to direct the extreme ultraviolet beam to a sample. In embodiments, the mirror assembly includes a hyperboloid optical surface, wherein the ellipsoid optical surface and the hyperboloid optical surface are arranged in a Wolter mirror configuration. In embodiments, the mirror assembly includes a substrate. In embodiments, the substrate includes a first portion, wherein the ellipsoid optical surface is located on the first portion of the substrate. In embodiments, the substrate includes a second portion, wherein the hyperboloid optical surface is located on the second portion of the substrate, wherein the first portion and the second portion form a monolithic body. In embodiments, extreme ultraviolet inspection system includes one or more detectors. In embodiments, extreme ultraviolet inspection system includes one or more collection optics, wherein the one or more collection optics are configured to direct a reflected extreme ultraviolet beam that has been reflected by the sample.

A method is disclosed, in accordance with one or more embodiments of the present disclosure. In embodiments, the method includes generating, with an extreme ultraviolet illumination source, an extreme ultraviolet beam. In embodiments, the method includes directing, with one or more mirror assemblies, the extreme ultraviolet beam to a sample. In embodiments, the mirror assembly includes an ellipsoid optical surface. In embodiments, the mirror assembly includes a hyperboloid optical surface, wherein the ellipsoid optical surface and the hyperboloid optical surface are arranged in a Wolter mirror configuration. In embodiments, the mirror assembly includes a substrate. In embodiments, the substrate includes a first portion, wherein the ellipsoid optical surface is located on the first portion of the substrate. In embodiments, the substrate includes a second portion, wherein the hyperboloid optical surface is located on the second portion of the substrate, wherein the first portion and the second portion form a monolithic body. In embodiments, the method includes directing, with one or more collection optics, reflected extreme ultraviolet light from the sample to one or more detectors. In embodiments, the method includes generating one or more measurements based on the reflected extreme ultraviolet light.

### BRIEF DESCRIPTION OF THE DRAWINGS

The numerous advantages of the disclosure may be better understood by those skilled in the art by reference to the accompanying figures.

FIG. 1A illustrates a perspective top view of a mirror assembly, in accordance with one or more embodiments of the present disclosure.

FIG. 1B illustrates a perspective side view of the mirror assembly, in accordance with one or more embodiments of the present disclosure.

FIG. 1C illustrates a top view of the mirror assembly, in accordance with one or more embodiments of the present disclosure.

FIG. 1D illustrates a side view of the mirror assembly, in accordance with one or more embodiments of the present disclosure.

FIG. 1E illustrates a portion the mirror assembly showing focal points, in accordance with one or more embodiments of the present disclosure.

FIG. 2 illustrates a schematic view of an extreme ultraviolet inspection system, in accordance with one or more embodiments of the present disclosure.

FIG. 3 illustrates a flow diagram of a method, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to a mirror assembly, wherein multiple (e.g., two) mirrors are built into a single structure. The mirrors of the mirror assembly may be arranged in a Wolter mirror configuration. In this way, the mirrors may be arranged such that light may incident on one mirror and get reflected onto the other, contacting both mirrors at very shallow angles, which may prevent the light from being absorbed by the mirrors. When compared to conventional designs with two separate mirrors needing alignment with respect to each other, the integration of elliptical and parabolic mirror into one piece may have several advantages. For example, integration of elliptical and hyperbolic mirror into one piece may eliminate the need for aligning two mirrors with respect to each other. By way of another example, integration of elliptical and hyperbolic mirror into one piece may enable easier alignment of the mirror assembly with other components in an optical system (e.g., an extreme ultraviolet system). By way of another example, integration of elliptical and parabolic mirror into one piece may achieve better long-term stability after being integrated into the entirety of an optical system.

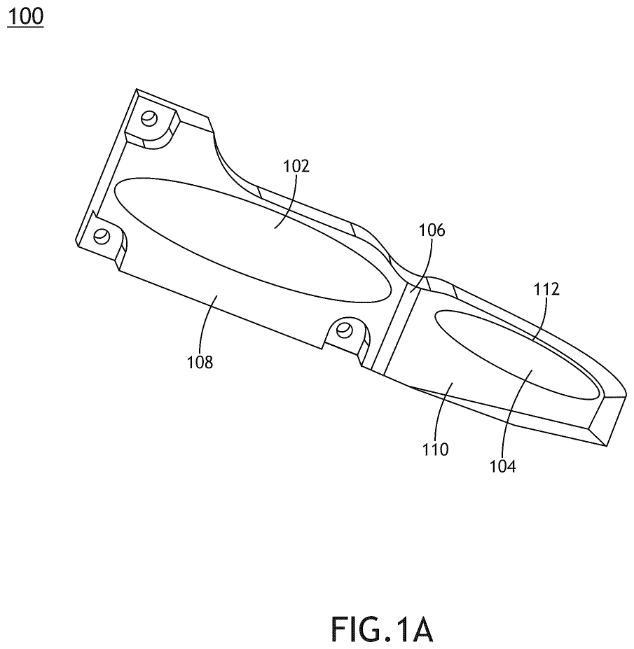

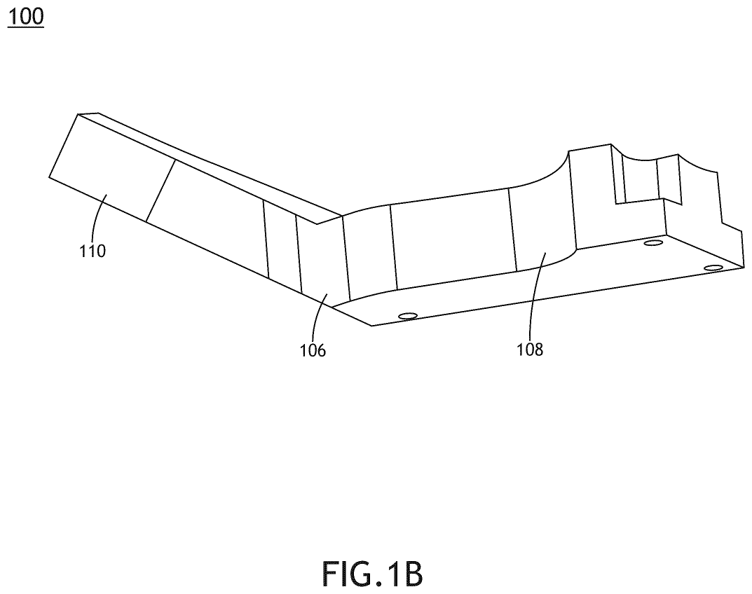

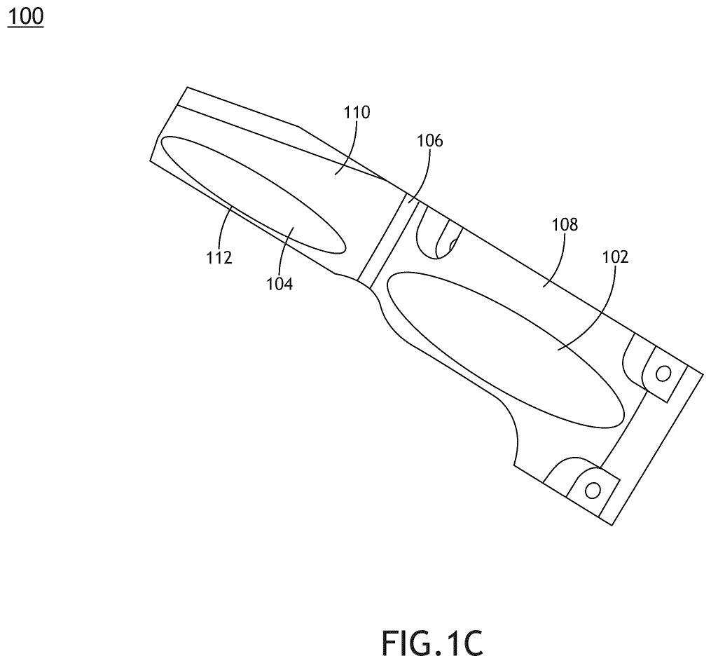

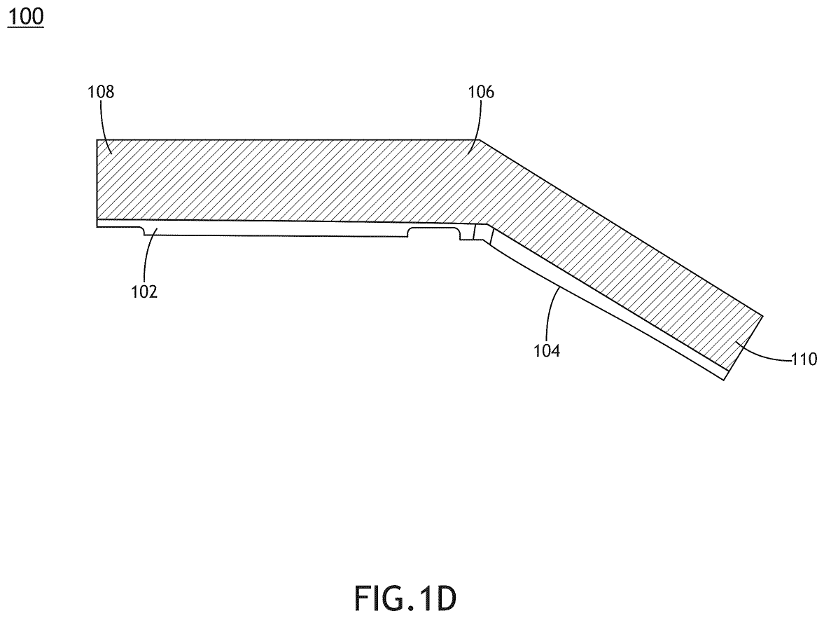

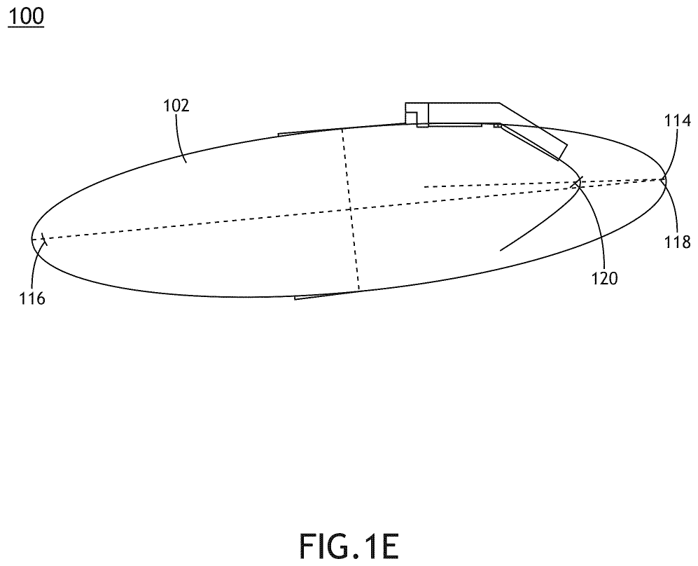

FIG. 1A illustrates a perspective top view of a mirror assembly 100, in accordance with one or more embodiments of the present disclosure. FIG. 1B illustrates a perspective side view of the mirror assembly 100, in accordance with one or more embodiments of the present disclosure. FIG. 1C illustrates a top view of the mirror assembly 100, in accordance with one or more embodiments of the present disclosure. FIG. 1D illustrates a side view of the mirror assembly 100, in accordance with one or more embodiments of the present disclosure.

In embodiments, the mirror assembly 100 includes an ellipsoid optical surface 102. The ellipsoid optical surface 102 may be a three-dimensional geometric shape. The ellipsoid optical surface 102 may resemble a stretched or squashed sphere. The ellipsoid optical surface 102 may be defined by three semi-axes, which determine its dimensions along three perpendicular axes.

In embodiments, the mirror assembly 100 includes hyperboloid optical surface 104. The hyperboloid optical surface 104 may be a three-dimensional, quadratic surface that can be visualized as a curved, shape resembling a hyperbola. The hyperboloid optical surface 104 may be characterized by its cross-sections, which may be hyperbolas in some planes and circles or ellipses in others.

The ellipsoid optical surface 102 and/or the hyperboloid optical surface 104 may be grazing incidence mirrors. Grazing incidence mirrors may be any mirror designed to reflect high-energy radiation (e.g., extreme ultraviolet (EUV)), which may normally pass through, or be absorbed by, materials at normal incidence angles (e.g., direct angles). Grazing incidence mirrors may operate by reflecting the incoming radiation at very shallow angles (e.g., close to parallel to the mirror surface) in order to prevent absorption of the radiation.

The ellipsoid optical surface 102 and the hyperboloid optical surface 104 may be arranged relative to each other such that they are in a Wolter mirror configuration. In this way, the ellipsoid optical surface 102 and the hyperboloid optical surface 104 may be arrange such that light reflects off of the ellipsoid optical surface 102 at a very shallow angle and is reflected onto the hyperboloid optical surface 104. This may be beneficial for high energy light and/or radiation, as the shallow angles permit deflection where the light may otherwise be absorbed.

It is noted that the ellipsoid optical surface 102 and the hyperboloid optical surface 104 may be any size relative to each other. For example, the ellipsoid optical surface 102 may have a surface area greater than the hyperboloid optical surface 104. By way of another example, the ellipsoid optical surface 102 may have a surface area equal to the hyperboloid optical surface 104. By way of another example, the ellipsoid optical surface 102 may have a surface area less than the hyperboloid optical surface 104.

In embodiments, the mirror assembly 100 includes a substrate 106. Broadly speaking, the substrate 106 may be any underlying substance or layer of the mirror assembly 100. The substrate 106 may make up a majority of the structure of the mirror assembly 100.

The substrate 106 may be made from any material suitable for use with high energy optics. For example, the substrate 106 may be made from fused silica.

Additionally, the substrate 106 may be ground down in order to obtain the desired surface finish. Further, the perimeter of the substrate 106 may include one or more chamfers in order to prevent the substrate 106 from having sharp edges.

The ellipsoid optical surface 102 and the hyperboloid optical surface 104 may be located on the substrate 106. For example, the ellipsoid optical surface 102 and the hyperboloid optical surface 104 may be inset into the substrate 106. By way of another example, the ellipsoid optical surface 102 and the hyperboloid optical surface 104 may be disposed on the surface of the substrate 106.

In embodiments, the substrate 106 includes a first portion 108 and a second portion 110. The first portion 108 and the second portion 110 may form a monolithic structure of the substrate 106. Additionally, the first portion 108 and the second portion 110 may be positioned at an angle relative to each other (e.g., an obtuse angle). The angle at which the first portion 108 and the second portion 110 may be positioned at an angle relative to each other may be determined to facilitate limited absorption of light or radiation and optimal imaging performance as it travels between the ellipsoid optical surface 102 and the hyperboloid optical surface 104.

The ellipsoid optical surface 102 may be located on the first portion 108 and the hyperboloid optical surface 104 may be located on the second portion 110. It is noted that the light or radiation may be configured to be first directed to the ellipsoid optical surface 102 and reflected off of the ellipsoid optical surface 102 and directed to the hyperboloid optical surface 104.

In embodiments, the mirror assembly 100 may include a freeboard 112. The freeboard 112 may be an area or a distance between an optically active area of the 100 (e.g., the ellipsoid optical surface 102 and/or the hyperboloid optical surface 104) and the edge of the substrate 106. The freeboard 112 may be designed such that is less than or equal to 750 micrometers. However, it should be noted that a freeboard less than or equal to 750 micrometers is exemplary rather than limiting, and the freeboard 112 may be of any size. Such a configuration may limit the form factor and reduce obscuration in a collection path.

FIG. 1E illustrates a portion of the mirror assembly 100 showing focal points, in accordance with one or more embodiments of the present disclosure.

It is noted that the ellipsoid optical surface 102 and the hyperboloid optical surface 104 may each include two focal points. For example, the ellipsoid optical surface 102 may include a first ellipsoid focal point 114 and a second ellipsoid focal point 116. By way of another example, the hyperboloid optical surface 104 may include first hyperboloid focal point 118 and a second hyperboloid focal point 120.

It is noted that the first ellipsoid focal point 114 may be proximal (e.g., near or at) the location of the first hyperboloid focal point 118. Such a configuration may promote the transfer of light between the ellipsoid optical surface 102 and the hyperboloid optical surface 104 to achieve best imaging performance from second ellipsoid focal point 116 to second hyperboloid focal point 120, while maintaining minimal losses or absorption of the light.

It is noted that the first ellipsoid focal point 114, the second ellipsoid focal point 116, the first hyperboloid focal point 118, and the second hyperboloid focal point 120 may all be coplanar with each other.

It is noted that the Wolter mirror configuration of the mirror assembly 100 as described herein may have several advantages. For example, the grazing incidence angle of the ellipsoid optical surface 102 and the hyperboloid optical surface 104 may reduce losses of energy due to absorption. By way of another example, the pair of ellipsoid optical surface 102 and hyperboloid optical surface 104 with overlapping foci may serve as a relay system, which provides the desired imaging performance with minimized aberration over a large field of view. By way of another example, the mirror assembly 100 may be designed for a specific field size (e.g., by using a desired magnification), which may maintain imaging quality. By way of another example, the mirror assembly 100 may be monolithic and compact (e.g., because of a small freeboard 112), which may enable easier alignment of the mirror assembly 100 within a larger system and minimize potential obscuration in the collection path.

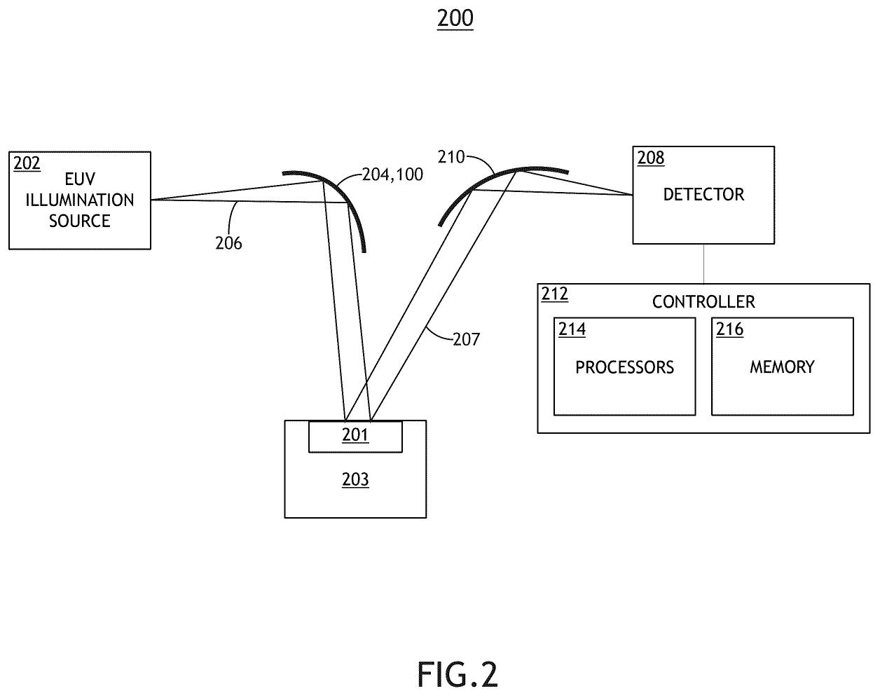

FIG. 2 illustrates an extreme ultraviolet inspection system 200, in accordance with one or more embodiments of the present disclosure.

In embodiments, the extreme ultraviolet inspection system 200 may include an extreme ultraviolet illumination source 202, one or more illumination optics 204 for illuminating a sample 201, one or more collection optics 210, one or more detectors 208, and one or more controllers 212 including one or more processors 214 and memory 216. The sample 201 may be disposed on a sample stage 203. The sample stage 203 may be configured to actuate the sample 201 (e.g., linearly actuate the sample 201 or rotationally actuate the sample 201).

The extreme ultraviolet illumination source 202 may include any illumination source known in the art to be suitable for the purposes contemplated by the present disclosure. For example, the extreme ultraviolet illumination source 202 may include a quasi-continuous wave laser. The extreme ultraviolet illumination source 202 may provide a high pulse repetition rate, low-noise, high power, stability, and reliability.

The extreme ultraviolet illumination source 202 may be configured to direct an extreme ultraviolet beam 206 onto a sample 201 via the one or more illumination optics 204. For example, the extreme ultraviolet illumination source 202 may direct an extreme ultraviolet beam 206 onto the one or more illumination optics 204, and the one or more illumination optics 204 may be configured to focus the extreme ultraviolet beam 206 onto the sample 201.

The illumination optics 204 may include any extreme ultraviolet-compatible optics known in the art suitable to precisely position the extreme ultraviolet beam 206 onto the sample 201. For example, the illumination optics 204 may include one or more mirror assemblies 100 configured to reflect extreme ultraviolet radiation. The illumination optics 204 may be configured to direct the extreme ultraviolet beam 206 at the sample 201 at any suitable angle, including, without limitation, normal or oblique angles.

Upon focusing on the sample 201, the extreme ultraviolet beam 206 may be reflected and/or scattered as a reflected extreme ultraviolet beam 207. The reflected extreme ultraviolet beam 207 may be collected by one or more detectors 208 via one or more collection optics 210. For example, the one or more collection optics 210 may collect the reflected extreme ultraviolet beam 207, and may focus the reflected extreme ultraviolet beam 207 onto one or more portions of the one or more detectors 208. The one or more detectors 208 may include any detector known in the art to be suitable for the purposes contemplated by the present disclosure. For example, the one or more detectors 208 may include any CCD-type camera.

The one or more collection optics 210 may include any extreme ultraviolet-compatible optics known in the art suitable to project the reflected extreme ultraviolet beam 207 onto the one or more detectors 208. For example, the one or more collection optics may include one or more mirrors configured to reflect extreme ultraviolet radiation.

The controller 212 may include one or more processors 214 and memory 216. The one or more processors 214 may be communicatively coupled to the one or more detectors 208. The one or more processors may be configured to execute a set of program instructions maintained in memory 216, wherein the set of program instructions are configured to cause the one or more processors to execute one or more steps of the present disclosure. The components of the extreme ultraviolet inspection system 200 may be communicatively coupled via one or more wireline connections (e.g., copper wire, fiber optic cable, soldered connection, and the like), or a wireless connection (e.g., RF coupling, IR coupling, data network communication, and the like). The controller 212 may be communicatively coupled to a user interface.

Upon focusing the reflected extreme ultraviolet beam 207 onto the one or more portions of the one or more detectors 208, the one or more controllers 212 may generate an image based on the reflected beam 207. For example, one or more processors of the one or more controllers 212 may analyze the intensity, phase, wave-front, and/or other characteristics of the reflected beam 207. The one or more processors may be configured to convert detected light of the reflected beam 207 into detected signals corresponding to one or more characteristics of the reflected beam 207. For example, the one or more processors may be configured to generate an image having different intensity values corresponding to different positions or portions of the sample 201.

By way of another example, the one or more processors 214 may be configured to receive the reflected extreme ultraviolet beam 207 (e.g., or a signal representing the reflected extreme ultraviolet beam 207) from the sample 201. In this way, the processors 214 may receive information necessary in analyzing one or more characteristics of the sample 201.

Based on the reflected beam 207, the one or more controllers 212 may be configured to generate one or more measurements based on the reflected extreme ultraviolet beam 207. For example, the one or more controllers 212 may compare the one or more detected signals corresponding to one or more characteristics of the reflected beam 207 to an expected signal based on the particular sample 201 in use. The expected signal based on a particular sample 201 may be stored in a memory of the extreme ultraviolet inspection system 200, or may be provided via user input. Based on the one or more wave-front aberrations measured by the extreme ultraviolet inspection system 200, the one or more controllers 212 may determine one or more adjustments for adjusting one or more components of the extreme ultraviolet inspection system 200. For example, the one or more controllers 212 may determine one or more adjustments to the position of the one or more illumination optics 204 and/or the one or more collection optics 210.

The one or more processors 214 of the one or more controllers 212 may be configured to execute program instructions maintained in memory 216. In this regard, the one or more processors 214 of the one or more controllers 212 may execute any of the various process steps described throughout the present disclosure. The memory 216 may store any type of data for use by any component of the extreme ultraviolet inspection system 200. For example, the memory 216 may store wave-front aberration data generated by the extreme ultraviolet inspection system 200, or the like.

The one or more processors 214 of a controller 212 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 214 may include any device configured to execute algorithms and/or instructions (e.g., program instructions stored in memory). In embodiments, the one or more processors 214 may be embodied as a desktop computer, mainframe computer system, workstation, image computer, parallel processor, networked computer, or any other computer system configured to execute a program configured to operate or operate in conjunction with the extreme ultraviolet inspection system 200, as described throughout the present disclosure. Moreover, different subsystems of the extreme ultraviolet inspection system 200 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 212 may include one or more controllers housed in a common housing or within multiple housings. In this way, any controller or combination of controllers may be separately packaged as a module suitable for integration into the extreme ultraviolet inspection system 200.

The memory 216 may include any storage medium known in the art suitable for storing program instructions executable by the associated one or more processors 214. For example, the memory 216 may include a non-transitory memory medium. By way of another example, the memory 216 may include, but is not limited to, a read-only memory (ROM), a random-access memory (RAM), a magnetic or optical memory device (e.g., disk), a magnetic tape, a solid-state drive, and the like. It is further noted that the memory 216 may be housed in a common controller housing with the one or more processors 214. In some embodiments, the memory 216 may be located remotely with respect to the physical location of the one or more processors 214 and the controller 212. For instance, the one or more processors 214 of the controller 212 may access a remote

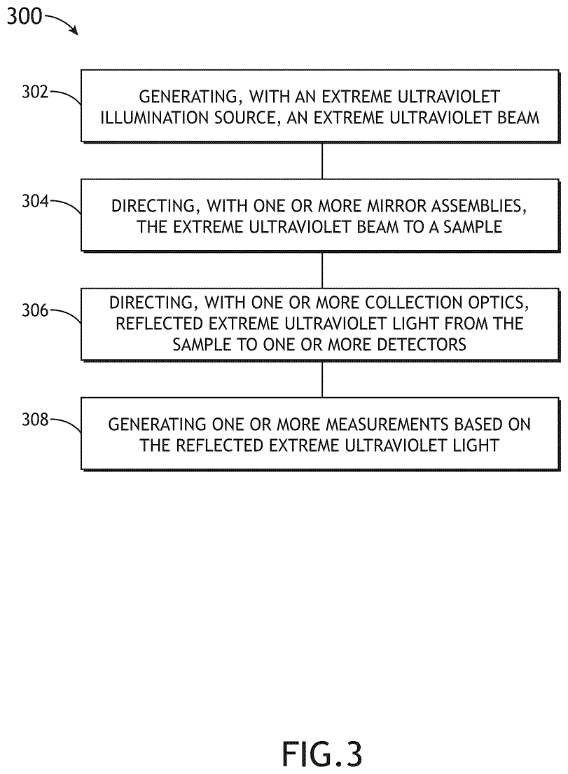

FIG. 3 illustrates a flow diagram of a method 300, in accordance with one or more embodiments of the present disclosure. Applicant notes that the embodiments and enabling technologies described previously herein in the context of the mirror assembly 100 and the extreme ultraviolet inspection system 200 should be interpreted to extend to the method 300. It is further noted, however, that the method 300 is not limited to the architecture of the mirror assembly 100 and the extreme ultraviolet inspection system 200.

In embodiments, the method 300 includes a step 302 of generating, with an extreme ultraviolet illumination source, an extreme ultraviolet beam. For example, any suitable source may be used as the extreme ultraviolet illumination source to generate the extreme ultraviolet beam. The extreme ultraviolet beam may have wavelengths around 10-120 nanometers. Such extreme ultraviolet beams may be used for imaging and metrology.

In embodiments, the method 300 includes a step 304 of directing, with one or more mirror assemblies, the extreme ultraviolet beam to a sample. For example, the mirror assemblies described herein may be used to direct the extreme ultraviolet beam to the sample. Such a system may be capable of directing the extreme ultraviolet beam to the sample without absorbing large portions of the extreme ultraviolet beam. Additionally, because the mirror assembly may be configured as a monolithic body instead of as discrete mirrors, there may be a limited need for setup or alignment of the mirror assembly. It is additionally noted that the mirror assembly may be used in conjunction with one or more additional illumination optics to direct the extreme ultraviolet beam to the sample.

In embodiments, the method 300 includes a step 306 of directing, with one or more collection optics, reflected extreme ultraviolet light from the sample to one or more detectors. For example, the sample may scatter the extreme ultraviolet beam that has been directed to it in order to for a reflected ultraviolet beam. The reflected ultraviolet beam may be directed to the one or more detectors with one or more mirrors, one or more lenses, or one or more beamsplitters.

In embodiments, the method 300 includes a step 308 of generating one or more measurements based on the reflected extreme ultraviolet light. For example, the detector may be coupled to one or more controllers, one or more processors, and/or a memory. Based on the reflected extreme ultraviolet beam received at the detectors, one or more measurements may be generated by the processors. The measurements may correspond to one or more dimensions of the sample, one or more features of the sample, or one or more manufacturing errors (e.g., defects) of the sample.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A mirror assembly comprising:
an ellipsoid optical surface;
a hyperboloid optical surface, wherein the ellipsoid optical surface and the hyperboloid optical surface are arranged in a Wolter mirror configuration; and
a substrate, wherein the substrate comprises;
a first portion, wherein the ellipsoid optical surface is located on the first portion of the substrate; and
a second portion, wherein the hyperboloid optical surface is located on the second portion of the substrate, wherein the first portion and the second portion form a monolithic body.

2. The mirror assembly of claim 1, wherein the ellipsoid optical surface and the hyperboloid optical surface are inset into the substrate.

3. The mirror assembly of claim 1, wherein the ellipsoid optical surface and the hyperboloid optical surface are grazing incidence mirrors.

4. The mirror assembly of claim 1, wherein the first portion and the second portion are positioned at an angle relative to each other.

5. The mirror assembly of claim 1, wherein the substrate is made of fused silica.

6. The mirror assembly of claim 1, wherein light is directed first to the ellipsoid optical surface.

7. The mirror assembly of claim 6, wherein the light is directed from the ellipsoid optical surface to the hyperboloid optical surface.

8. The mirror assembly of claim 6, wherein the light is extreme ultraviolet light.

9. The mirror assembly of claim 1, further comprising a freeboard, wherein the freeboard is a distance between one of the ellipsoid optical surface or the hyperboloid surface and an edge of the substrate.

10. The mirror assembly of claim 9, wherein the freeboard is less than or equal to 750 micrometers.

11. The mirror assembly of claim 1, wherein the ellipsoid optical surface has a surface area larger than the hyperboloid optical surface.

12. The mirror assembly of claim 1, wherein a first ellipsoid focal point is proximal to a first hyperboloid focal point.

13. The mirror assembly of claim 12, wherein the first ellipsoid focal point, a second ellipsoid focal point, the first hyperboloid focal point, and a second hyperboloid focal point are coplanar.

14. An extreme ultraviolet inspection system comprising:
an extreme ultraviolet illumination source, wherein the extreme ultraviolet illumination source is configured to generate an extreme ultraviolet beam;
one or more illumination optics, wherein the one or more illumination optics includes one or more mirror assemblies, wherein the one or more mirror assemblies are configured to direct the extreme ultraviolet beam to a sample, wherein each of the one or more mirror assemblies comprises:
an ellipsoid optical surface;
a hyperboloid optical surface, wherein the ellipsoid optical surface and the hyperboloid optical surface are arranged in a Wolter mirror configuration; and
a substrate, wherein the substrate comprises;
a first portion, wherein the ellipsoid optical surface is located on the first portion of the substrate; and
a second portion, wherein the hyperboloid optical surface is located on the second portion of the substrate, wherein the first portion and the second portion form a monolithic body;
one or more detectors; and
one or more collection optics, wherein the one or more collection optics are configured to direct a reflected extreme ultraviolet beam that has been reflected by the sample.

15. The extreme ultraviolet inspection system of claim 14, wherein the ellipsoid optical surface and the hyperboloid optical surface are inset into the substrate.

16. The extreme ultraviolet inspection system of claim 14, wherein the ellipsoid optical surface and the hyperboloid optical surface are grazing incidence mirrors.

17. The extreme ultraviolet inspection system of claim 14, wherein the first portion and the second portion are positioned at an angle relative to each other.

18. The extreme ultraviolet inspection system of claim 14, wherein the substrate is made of fused silica.

19. The extreme ultraviolet inspection system of claim 14, wherein the extreme ultraviolet beam is directed first to the ellipsoid optical surface.

20. The extreme ultraviolet inspection system of claim 14, wherein the extreme ultraviolet beam is directed from the ellipsoid optical surface to the hyperboloid optical surface.

21. The extreme ultraviolet inspection system of claim 14, further comprising a freeboard, wherein the freeboard is a distance between one of the ellipsoid optical surface or the hyperboloid surface and an edge of the substrate.

22. The extreme ultraviolet inspection system of claim 21, wherein the freeboard is less than or equal to 750 micrometers.

23. The extreme ultraviolet inspection system of claim 14, wherein the ellipsoid optical surface has a surface area larger than the hyperboloid optical surface.

24. The extreme ultraviolet inspection system of claim 14, wherein a first ellipsoid focal point is proximal to a first hyperboloid focal point.

25. The extreme ultraviolet inspection system of claim 24, wherein the first ellipsoid focal point, a second ellipsoid focal point, the first hyperboloid focal point, and a second hyperboloid focal point are coplanar.

26. The extreme ultraviolet inspection system of claim 14, further comprising:
a controller, wherein the controller includes one or more processors communicatively coupled to the one or more detectors, wherein the one or more processors are configured to execute a set of program instructions maintained in memory, wherein the set of program instructions are configured to cause the one or more processors to:
receive the reflected extreme ultraviolet beam from the sample; and
generate one or more measurements based on the reflected extreme ultraviolet beam.

27. A method comprising:
generating, with an extreme ultraviolet illumination source, an extreme ultraviolet beam;
directing, with one or more mirror assemblies, the extreme ultraviolet beam to a sample, wherein each of the one or more mirror assemblies comprises:
an ellipsoid optical surface;
a hyperboloid optical surface, wherein the ellipsoid optical surface and the hyperboloid optical surface are arranged in a Wolter mirror configuration; and
a substrate, wherein the substrate comprises;
a first portion, wherein the ellipsoid optical surface is located on the first portion of the substrate; and
a second portion, wherein the hyperboloid optical surface is located on the second portion of the substrate, wherein the first portion and the second portion form a monolithic body;
directing, with one or more collection optics, reflected extreme ultraviolet light from the sample to one or more detectors; and
generating one or more measurements based on the reflected extreme ultraviolet light.
